(19) United States
(12) Patent Application Publication
(10) Pub. No.: US 2026/0321621 A1
(43) Pub. Date: Oct. 15, 2026

(54) PROCESS FOR NMC CATHODE PRODUCTION FROM METAL FEEDSTOCKS

(71) Applicant: Nano One Materials Corp., Burnaby (CA)

(72) Inventors: Vahid Moradi, Burnaby (CA); Yash Adnani, Burnaby (CA); Khrystyna Herasymchuk, Burnaby (CA); Dorien Ying Peng, Burnaby (CA); Farhang Nesvaderani, Burnaby (CA)

(21) Appl. No.: 19/648,005

(22) Filed: Apr. 15, 2026

Related U.S. Application Data
(60) Provisional application No. 63/789,176, filed on Apr. 15, 2025.

(51) Int. Cl. H01M 4/525; H01M 4/02; H01M 4/131; H01M 10/0525

(52) U.S. Cl. CPC H01M 4/525; H01M 4/131; H01M 10/0525; H01M 2004/028

(57) ABSTRACT

Described is an improved process for the formation of lithium-ion metal oxide cathode active material. The process comprises: i) adding water to a reactor at a temperature of no more than 100° C.; ii) adding at least one elemental metal to a reactor, wherein the elemental metal comprises a metal selected from the group consisting of Ni, Mn, Co and Al; iii) adding a first aliquot of nitric acid to the reactor at a rate sufficient to maintain a temperature of no more than 100° C. to form a metal nitrate solution; iv) stirring the metal nitrate solution for at least a sufficient amount of time to reach a pH of ≤7 until the nitric acid added is in a molar ratio relative to moles of said element metal of at least 1:2.5 to no more than 1:5; v) adding Li+ to said reactor as a lithium salt until Li+ is in a molar ratio relative to moles of the element metal of at least of 0.9-1.1 or 0.4-0.6 to form a mixture comprising a solid and water in the reactor; vi) drying the mixture to remove the water from the solid; and vii) calcining the solid to form lithium-ion metal oxide cathode.

The present invention is related to an improved method of forming lithium-ion metal cathode active materials (CAM) for batteries. More specifically, the present invention is related to lithium-ion battery cathodes and an efficient method of preparing the CAMs in a one-pot process, utilizing a single reactor, from elemental metals.

### BACKGROUND

There is an ever-present demand for improvements in batteries. There are two primary applications for batteries with one being stationary applications and the other being mobile applications. With both stationary and mobile applications there is a desire for increased storage capacity, longer battery life, the ability to reach full charge quicker and lower cost. Lithium-ion batteries, comprising a lithium metal oxide cathode as the CAM, are highly advantageous as a suitable battery for most applications and they have found favor across the spectrum of applications. Still, there is a desire for an improvement in, particularly, the storage capability, recharge time, cost and storage stability of lithium-ion batteries.

The preparation of lithium-ion batteries comprising lithium and transition metal based cathodes in a rock-salt crystalline form or the spinel crystalline structure are described in U.S. Pat. Nos. 9,136,534; 9,159,999; 10,374,232; 11,121,370; 11,811,056 and 12,077,452 and U.S. Published Pat. Appl. Nos. 2021/0359300; 2022/0045315 and 2022/0064019 each of which are incorporated herein by reference. Cathode materials having a rock-salt crystalline form have general formula:

LiNiₐMn_{b}X_{c}O₂

wherein X is preferably Co or Al and a+b+c=1. Cathode materials having the spinel crystalline structure have general formula:

LiNiₓMn_{y}Co_{z}O₄

wherein x+y+z=2.

In a recently reported advance the CAM, either rock-salt or spinel, is formed by the digestion of metal carbonates in oxalic acid with Li₂CO₃ to make a mixed oxalate precursor. The mixed oxalate precursor is then calcined to make the CAM. The supply chain for transition metal carbonates is not well established since the supply chain is primarily based on the formation of metal sulfates.

Metal carbonates are typically made from metal sulfates. Metal sulfates are very low in metal content, 21 wt % for nickel for example, and therefore the cost associated with formation of metal carbonates from metal sulfates significantly mitigates the cost efficiencies associated with the oxalate process discussed above. In the formation of the metal sulfate the transition metals are extracted from the original source, often purified as metals, and then redissolved as acids. Therefore, the formation of metal carbonates, from metal sulfates, creates a Na₂SO₄ waste stream and the purity would typically be insufficient for use in the formation of CAMs for battery production unless additional, expensive, purification steps are utilized.

There has been a desire for an improved method of manufacturing lithium-ion cathodes and particularly lithium/manganese/nickel based cathodes in spinel and rock salt crystalline structures which is not encumbered by the precursor supply issues and waste stream issues common in the art. The present invention provides such a method.

### SUMMARY OF THE INVENTION

It is an object of this invention to provide an improved method of preparing a CAM for lithium-ion batteries.

More specifically, the present invention is related to improvements in the formation of precursors for CAM which eliminates the necessity of forming the metal sulfate and therefore eliminates the need of converting the metal sulfate to metal carbonate which streamlines the metal precursor production.

It is an object of the invention to provide an improved method for forming metal salt precursors of a lithium metal oxide wherein the metal salt precursors are calcined to form the lithium metal oxide cathode.

It is a particular object of the invention to provide an improved method for forming lithium-ion batteries comprising a transition metal-based cathode in a spinel crystalline structure or a rock-salt structure preferably chosen from NMC (Nickel Manganese Cobalt) and NCA (Nickel Cobalt Aluminum Oxide).

A particular advantage of the instant invention is in the ability to form high nickel CAMs wherein the precursor materials have been particularly difficult to obtain at a suitable cost and purity level for the formation of high nickel CAMs.

An embodiment of the invention is provided in a process for forming a lithium-ion metal oxide cathode active material comprising:
i) adding water to a reactor at a temperature of no more than 100° C.;
ii) adding at least one elemental metal to a reactor, wherein the elemental metal comprises a metal selected from the group consisting of Ni, Mn, Co and Al;
iii) adding a first aliquot of nitric acid to the reactor at a rate sufficient to maintain a temperature of no more than 100° C. to form a metal nitrate solution;
iv) stirring the metal nitrate solution for at least a sufficient amount of time to reach a pH of ≤7 until the nitric acid added is in a molar ratio relative to moles of said element metal of at least 1:2.5 to no more than 1:5;
v) adding Li+ to said reactor as a lithium salt until Li+ is in a molar ratio relative to moles of the element metal of at least of 0.9-1.1 or 0.4-0.6 to form a mixture comprising a solid and water in the reactor;
vi) drying the mixture to remove the water from the solid; and
vii) calcining the solid to form lithium-ion metal oxide cathode.

Yet another embodiment is provided in a process for forming a lithium-ion metal oxide cathode active material comprising:
i) adding water to a reactor at a temperature of no more than 100° C.;
ii) adding elemental nickel to the reactor;
iii) adding a first aliquot of nitric acid to the reactor at a rate sufficient to maintain a temperature of no more than 100° C. to form a metal nitrate solution;
iv) adding at least one elemental metal selected from the group consisting of Mn, Co and Al to said reactor;
v) stirring the metal nitrate solution for at least a sufficient amount of time to reach a pH of ≤7 until the nitric acid added is in a molar ratio relative to moles of nickel and element metal of at least 1:2.5 to no more than 1:5;
vi) adding Li+to the reactor as a lithium salt until Li+is in a molar ratio relative to moles of at least one element metal of at least of 0.9-1.1 or 0.4-0.6 to form a mixture;
vii) drying the mixture to remove water resulting in a solid; and
viii) calcining the solid to form the lithium-ion metal oxide cathode.

### BRIEF DESCRIPTION OF THE DRAWINGS

FIG. 1 is a flow chart representation of an embodiment of the invention.

FIG. 2 is a flow chart representation of another embodiment of the invention.

### DESCRIPTION

The instant invention is specific to an improved method for preparing a lithium-ion battery, and particularly the CAM of a lithium-ion battery. More particularly, the present invention is specific to an improved process for forming cathodes for use in a lithium-ion battery wherein the cathode is in a spinel crystalline form or a rock-salt form with preferred rock salt forms being NMC and NCA materials. Even more specifically, the present invention is directed to the formation of metal salt precursors, from elemental metal, directly without the requirement for the formation of sulfates and carbonates.

In a preferred embodiment the CAM of the instant invention comprises a lithium metal oxide cathode active material in a spinel crystal structure defined by the Formula I:

LiNiₓMn_{y}X_{z}E_{w}O₄ Formula I
wherein E is an optional dopant;
X is Co or Al; and
x+y+z+w=2 and w≤0.2; or
a rock-salt crystal structure defined by Formula II;

LiNiₐMn_{b}X_{c}G_{d}O₂ Formula II
wherein G is an optional dopant;
X is Co or Al; and
wherein a+b+c+d=1 and d≤0.1.

In a preferred embodiment the spinel crystal structure of Formula I, 0.4≤x≤0.6; 1.4≤y≤1.6 and z≤0.2. More preferably 0.5≤x≤0.55, 1.45≤y≤1.5 and z≤0.05. In a preferred embodiment neither x nor y is zero. In Formula I it is preferable that the Mn/Ni ratio is no more than 4, preferably at least 2.33 to less than 3.4 and most preferably at least 2.7 to less than 3.4.

In a preferred embodiment the rock-salt crystal structure of Formula II is a high nickel NMC wherein 0.5≤a≤0.9 and more preferably 0.58≤a≤0.62 as represented by NMC 622 or 0.78≤a≤0.82 as represented by NMC 811. In a preferred embodiment a=b=c as represented by NMC 111.

Throughout the specification the term NMCxxx or NCAxxx is a shorthand notation used in the art to represent the nominal relative ratio of nickel, manganese and cobalt in the case of NMCxxx, or the nominal relative ratio of nickel, cobalt and aluminum, in the case of NCAxxx, wherein x is ±10%. NMC811, for example, nominally represents LiNi_{0.8}Mn_{0.1}Co_{0.1}O₂, wherein the molar amount of Ni is 0.72-0.88, Mn is 0.09-0.11 and Co is 0.09-0.11, with the proviso that the combination of the molar amount of Ni, Mn and Co is as defined herein.

In the formulae throughout the specification, the lithium is defined stoichiometrically to balance charge with the understanding that the lithium is mobile between the anode and cathode. Therefore, at any given time, the cathode may be relatively lithium rich or relatively lithium depleted. In a lithium depleted cathode, the lithium will be below stoichiometric balance and upon charging the lithium may be above stoichiometric balance. Likewise, in formulations listed throughout the specification the metals are represented in charge balance with the understanding that the metal may be slightly rich or slightly depleted, as determined by elemental analysis, due to the inability to formulate a perfectly balanced stoichiometry in practice.

Dopants can be added to enhance the properties of the oxide such as electronic conductivity and stability. The dopant is preferably a substitutional dopant added in concert with the primary nickel, manganese, cobalt or aluminum. The dopant preferably represents no more than 20 mole %, preferably no more than 10 mole % and more preferably no more than 5 mole % of the oxide. Preferred dopants include Gd, Ti, Zr, Mg, Ca, Sr, Ba, Mg, Cr, Cu, Fe, Zn, V, Bi, Nb, combinations thereof, wherein B with Gd being particularly preferred. Dopants and coating materials may be added to the reactor either as carbonates, oxides, hydroxides or elemental metals as appropriate to make the desired composition.

A particular advantage of the instant invention is the ability to form the precursor oxide in a single reactor, referred to as a one-pot process, without the requirement of filtration. The process can be done at ambient pressure in water and with minimal manipulation of temperature. The process therefore requires minimal manufacturing process steps and equipment and the process is cost and space effective.

The invention will be described with reference to the figures which form an integral, but non-limiting, part of the specification presented for the purposes of explaining the invention. In the figures, similar elements will be numbered accordingly.

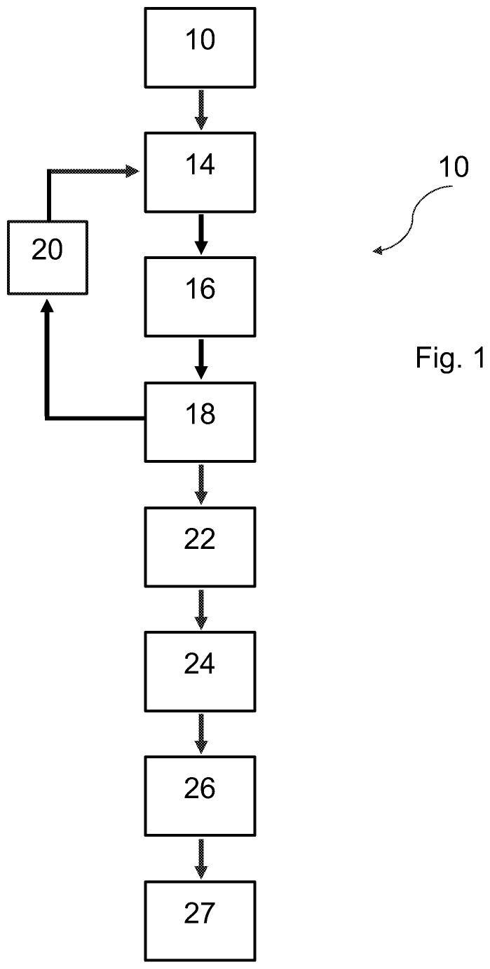

The process will be described with reference to the flow-chart of FIG. 1. In FIG. 1, the process, 10, comprises the addition of water to a reactor at 12. The water in the reactor may be at ambient temperature, however, it is preferable to increase the temperature to increase the reaction rate. In a preferred embodiment, the temperature of the water is heated to an activation temperature of at least 40° C. with a particular preference for the temperature of the water to be maintained below 100° C. during the addition of reagents as will be further described herein. Cooling of the water is optional and neither preferred nor advised due to the lack of a necessity and the additional manufacturing complexities and cost associated therewith.

With further reference to FIG. 1, at least one metal, in elemental form, is added with or to the water in the reactor at 14. At least one metal is preferably selected from Ni, Mn, Co and Al. In a particularly preferred embodiment, the nickel is added initially with other metals to follow as described further herein. Throughout the process the metals will be added in the molar ratio of the desired CAM, regardless of the time of addition within the process as would be understood to those of skill in the art.

With further reference to FIG. 1, a first aliquot of nitric acid is added to the reactor with or comprising the water and elemental metal at 16. This first aliquot comprises at least 1 molar nitric acid in water, and preferably at least 1.5 molar nitric acid in water. The rate of addition of nitric acid to the reactor is at a rate sufficient to maintain a temperature of no more than 100° C. thereby forming a metal nitrate solution at 18. If less than all elemental metals were previously added to the reactor, an additional addition process, 20, can be utilized wherein those additional metals necessary to achieve the desired stoichiometry of the CAM are added, or dopants are added. The nitric acid addition continues until the molar ratio of added nitric acid to the total moles of all added metal is at least 1:2.5 to no more than 1:5. The nitric acid solution is allowed to react at 22 for a sufficient period of time to reach a pH of no more than 7. In a particularly preferred embodiment, the mixture is stirred during the reaction and more preferably the stirring is sufficient to achieve turbulent flow in the reactor.

With further reference to FIG. 1, preferably after completion of the reaction at 22, Li⁺ is added to the reactor at 24 in an amount sufficient to achieve a molar ratio of Li⁺ relative to added elemental metal of at least 0.9-1.1 or 0.4-0.6. Li⁺ is added as a salt. Preferably, the salt is selected from the group consisting of Li₂CO₃ and LiOH, thereby forming a mixture comprising a solid, lithium nitrate and water in the reactor.

With further reference to FIG. 1, the mixture comprising a solid, lithium nitrate and water is dried to remove the water at 26, preferably without filtering, resulting in a dry lithium metal oxide cathode precursor comprising metals and lithium in substantially stoichiometric relationship of the desired lithium metal oxide cathode active material. The drying process is not particularly limited with spray drying and drum drying being suitable for demonstrating the invention. Spray drying is particularly preferred at commercial scale. Preferably, filtration and/or drying is not conducted prior to adding the Li+.

With further reference to FIG. 1, the dry lithium metal oxide cathode precursor is calcined resulting in a lithium metal oxide cathode active material. The calcination temperature can vary from 400° C. to 1000° C. It is preferable that the calcining occur in a single heating step without a return to ambient temperature until calcining is complete.

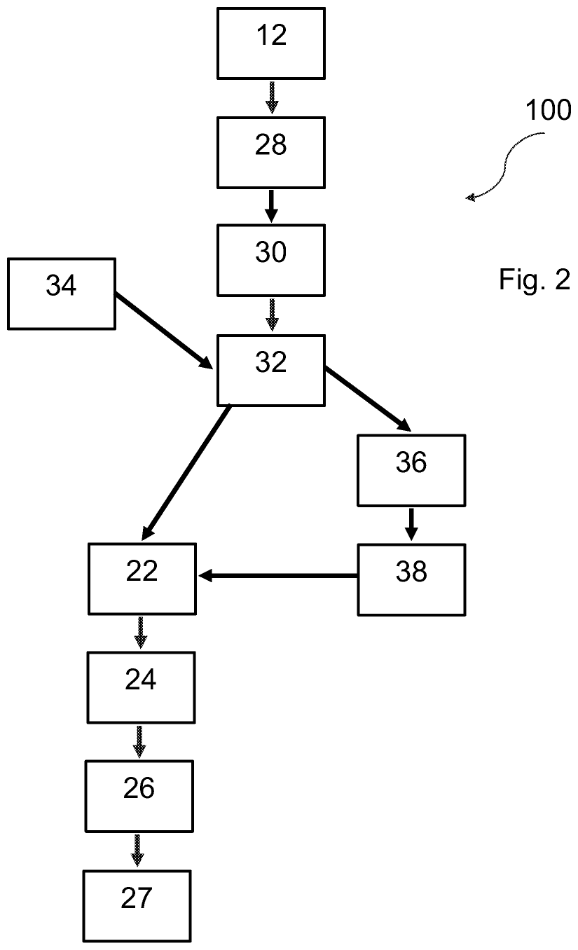

Another embodiment of the invention will be described with reference to the flow-chart of FIG. 2. In FIG. 2, the process, 100, comprises the addition of water to a reactor at 12.

With further reference to FIG. 2, nickel metal, in elemental form, is added to or with the water in the reactor, at 28, with addition of a first aliquot of nitric acid which is added to the reactor at 30. The rate of addition of nitric acid to the reactor is at a rate sufficient to maintain a temperature of no more than 100° C. thereby forming a nickel nitrate solution at 32. In one embodiment, the nitric acid addition continues until the molar ratio of added nitric acid to the total moles of nickel is at least 1:2.5 to no more than 1:5. In another embodiment additional metals, preferably comprising at least metals selected from the group consisting of Mn, Co and Al, and optionally additional dopants, are added at 34 after the initial addition of nitric acid, with the addition of nitric acid continuing as a second aliquot until the molar ratio of added nitric acid to the total moles of metal is at least 1:2.5 to no more than 1:5. The reaction is allowed to proceed with all metals and nitric acid added until the pH is no more than 7 at 22. Alternatively, the reaction can continue with only nickel and nitric acid at 32 until the pH is no more than 7 to from a nickel nitrate solution at 32. At least one additional metal selected from the group consisting of Mn, Co and Al and optional dopants are added to the reactor at 36 either in concert with, or followed by, the addition of nitric acid at 38 wherein the nitric acid is added at a rate sufficient to maintain a temperature of no more than 100° C. and the reaction is allowed to proceed at 22 until the pH is no more than 7.

With further reference to FIG. 2, preferably after completion of the reaction at 22, Li⁺ is added to the reactor at 24 as discussed previously, the mixture comprising a solid and water. The mixture is dried to remove the water at 26 and the solid is calcined at 27.

A particular feature of the invention is optional elimination of the filtration step which eliminates a processing step and maintains the lithium in the proper stoichiometric relationship with the metals. It is particularly preferable to limit the amount of water added to the reactor since the water is removed during the drying step and minimizing the amount of water to be removed improves drying efficiency. The primary sources of water are the water initially added to the reactor and the water added with the nitric acid. Concentrated nitric acid solution is preferable with nitric acid solution which is at least 1.5 molar being preferred. More preferably, the nitric acid solution is at least 5 molar, more preferably at least 9 molar and more preferably at least 12 molar.

The amount of water added to the reactor is preferably minimized with the lower limit being a sufficient amount of water to facilitate the reaction and allow for stirring and mixing of the metals and nitric acid. In a preferred embodiment, the amount of water added to the reactor and the water added with the nitric acid provide a wt % of metals in the water after the reaction and before any water removal of at least 10 wt % metal. More preferably, the wt % of metals in the water after the reaction and before water removal is at least 50 wt % metal.

In one embodiment, an oxidizer can be added to the reactor to facilitate the oxidation of the metal, and particularly, the oxidation of nickel. The optional oxidizer can be added prior to the addition of elemental metal to the reactor or prior to addition of lithium to the reactor. It is most preferable that the optional oxidizer be added prior to or during the addition of nitric acid. The molar ratio of oxidizer to moles of metal is preferably at least 1.2 to no more than 1.3. More specifically, the molar ratio of oxidizer to moles of nickel is preferably at least 1.2 to no more than 1.3. A particularly preferred oxidizer is hydrogen peroxide due to the absence of undesirable reaction products.

The cathode material is optionally treated with a phosphate salt, XPO₄, wherein X is an atom or atoms necessary to balance charge. X may be a monovalent atom, a divalent atom or a trivalent atom with the understanding that combinations may be used as desired. It is particularly preferred that X is easily removed either by washing or vaporization after application. The phosphate salt is applied to the surface of the metal oxide wherein the phosphate moiety forms MnPO₄ on the surface of the metal oxide, or is bonded to the surface of the metal oxide. The manganese is preferably predominantly in the +3 oxidation state with preferably less than 10% of the surface manganese being in the +2 oxidation state and the manganese thereby stabilized against reduction to Mn²⁺ at the surface. The reaction liberates X which is removed by washing or vaporization. In preferred phosphates, X is selected from NH₄⁺, H⁺, Li⁺, Na⁺, and combinations thereof. Particularly preferred phosphates include (NH₄)₃PO₄, (NH₄)₂HPO₄, (NH₄)H₂PO₄, and H₃PO₄ due to the ease of removal of X after formation of the surface manganese phosphate. It is preferred that the native manganese oxide of the calcined oxide precursor be reacted with phosphate as opposed to an added manganese or other metal. Therefore, it is preferred that the added phosphate be relatively free of Mn and more preferably less than 1 wt % manganese. It is preferable that no Mn⁺² be added with the phosphate or after formation of the oxide. It is preferable that there be no separate manganese phosphate phase such as manganese phosphate as a distinct phase on the surface. It is preferable that the phosphate ligate the surface of the metal oxide.

The metal powder is mixed in the intended ratios in the ultimate CAM. By way of non-limiting example, if LiNi_{0.8}Mn_{0.1}Co_{0.1}O₂ is to be prepared the metal powder would have 8 molar parts Ni, 1 molar part Mn and 1 molar part Co with one molar part Li added prior to calcining. The elemental metal feedstock particle size may be adjusted so that the elemental metals react at a similar rate. By way of non-limiting example, the particle size may be inversely related to the reaction rate such that the surface area increase mitigates the difference in reaction rate. Since the reaction rate follows the relationship Co>Mn>Ni, it may be advantageous to utilize particle size differences which follow the same relationship.

Sulfur concentration, as an impurity, is particularly important for nickel wherein higher sulfur concentrations increase the reaction rate. It would be understood to those in the art that sulfur is undesirable for electrical performance and therefore sulfur is typically to be avoided, or below detectable limits. However, a small level of impurity may be acceptable to balance the reaction rate with electrical performance. A sulfur impurity of no more than 0.05 wt %, relative to nickel metal, can be effective at sufficiently increasing the reaction rate with the carbonate without significant decrease in electrical performance.

The dried powders may be transferred into the calcining system batch-wise or by means of a conveyor belt. In large scale production, this transfer may be continuous or batch. The calcining system may be a box furnace utilizing ceramic trays or saggers as containers, a rotary calciner, a fluidized bed, which may be co-current or counter-current, a rotary tube furnace and other similar equipment without limit thereto.

The heating rate and cooling rate during calcinations depend on the type of final product desired. Generally, a heating rate of about 5° C. per minute is preferred but the usual industrial heating rates are also applicable.

The final powder obtained after the calcining step is a fine, ultrafine or nanosize powder that may not require additional crushing, grinding or milling as is currently done in conventional processing. Particles are relatively soft and not sintered as in conventional processing.

The final calcined oxide powder is preferably characterized for surface area, particle size by electron microscopy, porosity, chemical analyses of the elements and also the performance tests required by the preferred specialized application.

The spray dried oxide precursor is preferably very fine and nanosized.

A modification of the spray dryer collector such that an outlet valve opens and closes as the spray powder is transferred to the calciner can be implemented. Batchwise, the spray dried powder in the collector can be transferred into trays or saggers and moved into a calciner. A rotary calciner or fluidized bed calciner can be used to demonstrate the invention. The calcination temperature is determined by the composition of the powder and the final phase purity desired. For most oxide type powders, the calcination temperatures range from as low as 400° C. to slightly higher than 1000° C. After calcination, the powders are sieved as these are soft and not sintered. The calcined oxide does not require long milling times nor classifying to obtain narrow particle size distribution.

The LiM₂O₄ spinel oxide has a preferred crystallite size of 1-5 μm. The LiMO₂ rock salt oxide has a preferred crystallite size of about 50 -250 nm and more preferably about 150-200 nm.

The process is easily scalable for large scale manufacturing using presently available equipment and/or innovations of the present industrial equipment. For the purposes of the instant application ambient pressure is defined as atmospheric pressure (0.9-1.1 atmosphere) wherein minimal, and preferably no, alteration of pressure is utilized.

A battery is formed by combining the cathode active material with an anode, a separator between the anode and cathode active material and an electrolyte as well known in the art and not otherwise discussed herein.

### EXAMPLES

### Representative Electrode preparations

Composite electrodes are prepared by mixing the active material with 10 wt % conductive carbon black, as a conductive additive, 5 wt % polyvinylidene fluoride (PVDF), as a binder, dissolved in N-methyl-2-pyrrolidinone (NMP) solvent. The slurry would be cast on graphite-coated aluminum foil and dried overnight at 60° C. under vacuum. Electrode disks with an area of 1.54 cm² are cut from the electrode sheets with a typical loading of 4 mg·cm⁻².

### Representative Coin Cell Assembly

Coin cells are assembled in an argon-filled glovebox. Lithium foil (340 μm) is used as counter and reference electrodes in half-cells, and commercial Li₄Ti₅O₁₂ (LTO) composite electrodes are used as counter and reference electrodes in full-cells thereby forming a battery. 1 M LiPF₆ in 7:3 (vol %) ethylene carbonate (EC):diethylene carbonate (DEC) are used as the electrolyte. The electrodes are separated by one or two 25 μm thick sheets of Celgard® membranes in half-cells, and one sheet of Celgard membrane full-cells.

### Representative Cycling Protocol

The spinel cathode cells are galvanostatically cycled in the voltage range of 3.5 V-4.9 V at various C-rates (1 C rate equivalent to 146 mAg⁻¹) at 25° C., using an Arbin Instrument battery tester (model number BT 2000). A constant voltage charging step at 4.9 V for 10 minutes is applied to the cells at the end of 1 C or higher rate galvanostatic charging steps. The rock-salt NMC cells are galvanostatically cycled in the voltage range of 2.7 V-4.35 V at various C-rates (1 C rate equivalent to 200 mAg⁻¹) at 25° C. A constant voltage charging step at 4.35 V for 10 minutes is applied to the cells at the end of 1 C or higher rate galvanostatic charging step.

The invention has been described with reference to the preferred embodiments without limit thereto. One of skill in the art would realize additional embodiments and improvements which are not specifically set forth herein but which are within the scope of the invention as more specifically set forth in the claims appended hereto.

1. A process for forming a lithium-ion metal oxide cathode active material comprising:
i) adding water to a reactor at a temperature of no more than 100° C.;
ii) adding at least one elemental metal to a reactor, wherein the elemental metal comprises a metal selected from the group consisting of Ni, Mn, Co and Al;
iii) adding a first aliquot of nitric acid to the reactor at a rate sufficient to maintain a temperature of no more than 100° C. to form a metal nitrate solution;
iv) stirring the metal nitrate solution for at least a sufficient amount of time to reach a pH of ≤7 until the nitric acid added is in a molar ratio relative to moles of said element metal of at least 1:2.5 to no more than 1:5;
v) adding Li+ to said reactor as a lithium salt until Li+ is in a molar ratio relative to moles of the element metal of at least of 0.9-1.1 or 0.4-0.6 to form a mixture comprising a solid and water in the reactor;
vi) drying the mixture to remove the water from the solid; and
vii) calcining the solid to form lithium-ion metal oxide cathode,
wherein said lithium-ion metal oxide cathode is defined by Formula I:
LiNiₓMn_{y}X_{z}E_{w}O₄ Formula I
wherein E is an optional dopant;
X is Co or Al;
x+y+z+w=2 and w≤0.2; or
by Formula II;
LiNiₐMn_{b}X_{c}G_{d}O₂ Formula II
wherein G is an optional dopant;
X is Co or Al; and
wherein a+b+c+d=1 and d≤0.1.

2. The process for forming a lithium-ion metal oxide cathode active material of claim 1 further comprising heating said water.

3. (canceled)

4. The process for forming a lithium-ion metal oxide cathode active material of claim 1 wherein said first aliquot of nitric acid comprises adding an acid solution comprising at least 1 molar nitric acid in water.

5. (canceled)

6. The process for forming a lithium-ion metal oxide cathode active material of claim 1 further comprising adding at least one second elemental metal to said reactor, wherein said second elemental metal comprises a metal selected from the group consisting of Ni, Mn, X, E and G.

7. (canceled)

8. The process for forming a lithium-ion metal oxide cathode active material of claim 6 further comprising adding a second aliquot of nitric acid to said metal nitrate solution, wherein said first aliquot and said second aliquot are combined to form said molar ratio of said nitric acid relative to moles of said at least one elemental metal of at least 1:2.5 to no more than 1:5.

9. The process for forming a lithium-ion metal oxide cathode active material of claim 1 wherein said mixture comprises lithium nitrate.

10. (canceled)

11. The process for forming a lithium-ion metal oxide cathode active material of claim 1 wherein said lithium salt is selected from the group consisting of Li2CO3 and LiOH.

12. The process for forming a lithium-ion metal oxide cathode active material of claim 1 further comprising adding an oxidizer to said reactor prior to said adding said lithium salt.

13. (canceled)

14. The process for forming a lithium-ion metal oxide cathode active material of claim 12 wherein said oxidizer is in a molar ratio relative to moles of said elemental metal in said reactor of at least 1:2 to no more than 1:3.

15. (canceled)

16. (canceled)

17. (canceled)

18. The process for forming a lithium-ion metal oxide cathode active material of claim 1 wherein said process is at ambient pressure.

19. The process for forming a lithium-ion metal oxide cathode active material of claim 1 wherein said elemental metal added to said reactor is at least 10 wt % of said water in said reactor prior to said drying.

20. (canceled)

21. (canceled)

22. (canceled)

23. The process for forming a lithium-ion metal oxide cathode active material of claim 1 wherein said process does not include filtration or drying prior to adding of said Li+.

24. The process for forming a lithium-ion metal oxide cathode active material of claim 1 wherein calcining comprises a single heating step.

25. The process for forming a lithium-ion metal oxide cathode active material of claim 1 wherein in said Formula I:
0.4≤x≤0.6;
1.4≤y≤1.6;
and z≤0.2.

26. (canceled)

27. The process for forming a lithium-ion metal oxide cathode active material of claim 1 wherein in said Formula I neither x nor y is zero.

28. The process for forming a lithium-ion metal oxide cathode active material of claim 1 wherein in said Formula I has a Mn/Ni ratio of no more than 4.

29. The process for forming a lithium-ion metal oxide cathode active material of claim 28 wherein said Mn/Ni ratio is at least 2.33 to no more than 3.4.

30. (canceled)

31. The process for forming a lithium-ion metal oxide cathode active material of claim 1 wherein in said Formula II 0.5≤a≤0.9.

32. (canceled)

33. (canceled)

34. The process for forming a lithium-ion metal oxide cathode active material of claim 1 wherein said E or said G is selected from the group consisting of Gd, Ti, Zr, Mg, Ca, Sr, Ba, Mg, Cr, Cu, Fe, Zn, V, Bi, Nb and B.

35. The process for forming a lithium-ion metal oxide cathode active material of claim 34 wherein said E or said G is Gd.

36. A process for forming a battery comprising combining a lithium-ion metal oxide cathode active material of claim 1 with an anode, a separator between said anode and said cathode and an electrolyte.

37. A process for forming a lithium-ion metal oxide cathode active material comprising:
i) adding water to a reactor at a temperature of no more than 100° C.;
ii) adding elemental nickel to the reactor;
iii) adding a first aliquot of nitric acid to the reactor at a rate sufficient to maintain a temperature of no more than 100° C. to form a metal nitrate solution;
iv) adding at least one elemental metal selected from the group consisting of Mn, Co and Al to said reactor;
v) stirring the metal nitrate solution for at least a sufficient amount of time to reach a pH of ≤7 until the nitric acid added is in a molar ratio relative to moles of nickel and element metal of at least 1:2.5 to no more than 1:5;
vi) adding Li+ to the reactor as a lithium salt until Li+ is in a molar ratio relative to moles of at least one element metal of at least of 0.9-1.1 or 0.4-0.6 to form a mixture;
vii) drying the mixture to remove water resulting in a solid; and
viii) calcining the solid to form the lithium-ion metal oxide cathode, wherein said lithium-ion metal oxide cathode is defined by Formula I:
LiNiₓMn_{y}X_{z}E_{w}O₄ Formula I
wherein E is an optional dopant;
X is Co or Al;
x+y+z+w=2 and w≤0.2; or
by Formula II;
LiNiₐMn_{b}X_{c}G_{d}O₂ Formula II
wherein G is an optional dopant;
X is Co or Al; and
wherein a+b+c+d=1 and d≤0.1.

38. (canceled)

39. The process for forming a lithium-ion metal oxide cathode active material of claim 38 wherein said first aliquot is added to said reactor prior to said adding said at least one elemental metal.

40. The process for forming a lithium-ion metal oxide cathode active material of claim 38 further comprising adding a second aliquot of nitric acid wherein said first aliquot and said second aliquot comprises nitric acid in a molar ratio relative to said moles of said nickel and said moles of said at least one elemental metal of at least 1:2.5 to no more than 1:5.

41. The process for forming a lithium-ion metal oxide cathode active material of claim 40 wherein said adding said at least one elemental metal is prior to adding said second aliquot.

42. The process for forming a lithium-ion metal oxide cathode active material of claim 37 further comprising heating said water.

43. (canceled)

44. The process for forming a lithium-ion metal oxide cathode active material of claim 37 wherein said first aliquot of nitric acid comprises adding an acid solution comprising at least 1 molar nitric acid in water.

45. (canceled)

46. The process for forming a lithium-ion metal oxide cathode active material of claim 37 further comprising adding at least one second elemental metal to said reactor wherein second metal solution comprises a metal selected from the group consisting of Ni, Mn, X, E and G.

47. The process for forming a lithium-ion metal oxide cathode active material of claim 46 wherein said at least one second elemental metal is a metal not included in said first elemental metal.

48. The process for forming a lithium-ion metal oxide cathode active material of claim 46 further comprising adding adding a second aliquot of nitric acid to said metal nitrate solution wherein said first aliquot and second second aliquot are combined to form said molar ratio of said nitric acid relative to moles of said at least one element metal of at least 1:2.5 to no more than 1:5.

49-76. (canceled)
